(19) United States
(12) Patent Application Publication
(10) Pub. No.: US 2024/0358565 A1
(43) Pub. Date: Oct. 31, 2024

(54) Aerospace-Based Healthcare Systems

(71) Applicant: THINKING ROBOTSTUDIOS INC. AND MASH.FLIGHTS, Truro (CA)

(72) Inventors: Kendall Joudrie, Nova Scotia (CA); Jourdan Dakov, Nova Scotia (CA)

(73) Assignee: THINKING ROBOTSTUDIOS INC. AND MASH.FLIGHTS, Truro (CA)

(21) Appl. No.: 18/647,922

(22) Filed: Apr. 26, 2024

Related U.S. Application Data
(60) Provisional application No. 63/462,850, filed on Apr. 28, 2023.

(30) Foreign Application Priority Data
Apr. 28, 2023 (US) 63462850

(51) Int. Cl. A61G 3/00; A61G 10/00; B64D 11/00

(52) U.S. Cl. CPC A61G 3/001; A61G 10/00; B64D 11/00; A61G 2220/10; B64D 2011/0046

(57) ABSTRACT

A mobile transportation system, having a plurality of modules, including a self-sufficient hospital facility, small-scale medical device manufacturing facility, vaccine production facility, pharmaceutical production facility, sterilization facility, and food production facility, as well as an accommodation facility; wherein each of said plurality of modules, when necessary can be unloaded from the aerospace object and connected to other modules to become part of a larger modular facility with specific purposes, to allows for customization of the facility depending on the medical or other needs.

### BACKGROUND

### 1. Field of the Invention

This invention relates to a medical module for an aerospace vehicle, as well as a mobile hospital. In particular this invention relates to a mobile transportation system having a plurality of modules including a self-sufficient hospital facility.

### 2. Prior Art

Healthcare delivery in remote and underserved areas around the globe, as well as areas impacted by natural disasters or military conflicts, has always been a challenge and can cover vast distances from resources with little time for authorities and agencies to react. Often, these areas lack the necessary medical infrastructure and resources to provide adequate care for the population. Moreover, in times of crisis, the existing medical facilities may be overwhelmed or inaccessible due to damage or destruction of infrastructure. Therefore, there is a need for an innovative comprehensive healthcare delivery system that can be quickly deployed and can provide advanced and comprehensive medical care to patients in such areas, quickly and without geographical restrictions.

In the face of large-scale natural disasters such as earthquakes, floods, wildfires local hospitals often find themselves overwhelmed, exacerbated by disruptions to essential utilities such as electricity, water, and fuel. Current responses typically involve the deployment of medical tents to provide rudimentary first-aid services. However, the limited capacity of such facilities, compounded by constrained staff and resources, often proves inadequate, particularly for addressing the needs of casualties requiring extensive or specialized medical care.

Similar challenges are encountered in conflict zones, where organizations such as the Red Cross establish casualty clearing stations and emergency medical facilities. While these establishments play a crucial role in delivering initial medical attention, they may lack the requisite equipment and expertise for complex surgical procedures.

As a result of these inherent limitations, many patients in disaster and conflict zones receive suboptimal medical care, leading to chronic health issues and fatalities, despite the potential for successful treatment with appropriate medical resources. Consequently, there exists a pressing demand for deployable hospital systems capable of efficiently managing large casualty volumes in remote or resource-constrained environments.

The proposed innovation pertains to a mobile modular healthcare facility designed for deployment in remote areas and transported by aerospace objects. This solution offers several distinct advantages. Firstly, its swift delivery to regions where conventional hospitals are inaccessible by ground transportation ensures timely access to critical medical care during emergencies. Moreover, the modular architecture of the facility allows for scalable deployment, facilitating adaptation to the specific requirements of disaster zones. Additionally, the incorporation of self-sufficient features such as independent power generation, water supply, and air purification ensures continuous operation even in the face of compromised local infrastructure.

Furthermore, the modular nature of the healthcare facility renders it suitable for utilization in space environments, including spaceships and stations. By encompassing a diverse array of medical equipment and supplies within a modular framework, spacecraft and stations can enhance their onboard healthcare capabilities, thereby advancing medical support in space exploration endeavors.

### SUMMARY

The presented disclosure relates to an aerospace-based healthcare system that addresses challenges such as healthcare delivery in remote and underserved areas around the globe, as well as areas impacted by natural disasters or military conflicts by providing mobile surgical and Intensive Care Unit (ICU) capabilities, laboratory and diagnostic services, all medical imaging modalities, and patient-specific care services. Additionally, the system is designed to be optimized for deployment in remote and underserved areas around the globe as well as areas stricken by natural disasters or military conflicts to provide advanced, uncompromised, medical care to the population it serves.

Overall, the aerospace-based healthcare system represents a significant advancement in mobile medical care and is expected to have a transformative impact on healthcare delivery in remote and underserved areas around the globe as well as areas stricken by natural disasters or military conflicts.

It is an aspect of this invention to provide a mobile transportation system, having a plurality of modules, including a self-sufficient hospital facility, small-scale medical device manufacturing facility, vaccine production facility, pharmaceutical production facility, sterilization facility, and food production facility, as well as an accommodation facility; wherein each of said plurality of modules, when necessary can be unloaded from the aerospace object and connected to other modules to become part of a larger modular facility with specific purposes, to allows for customization of the facility depending on the medical or other needs.

It is another aspect of this invention to provide a medical module for an aerospace vehicle comprising; a top surface spaced from a bottom surface; first and second spaced ends; a first side surface spaced from a second side surface, wherein the second side surface is different from said first side surface; wherein said bottom surface extends beyond said first side surface to present a walking surface; and wherein said top bottom and first and second side surfaces are configured to maximize the use of an interior of said aerospace vehicle.

### BRIEF DESCRIPTION OF DRAWINGS

Embodiments of the disclosure will now be described, by way of example only, with reference to the accompanying drawings, in which:

FIG. 1 is a schematic diagram of a section of the aircraft loaded with hospital modules according to an embodiment;

FIG. 2 is a schematic diagram of perspective view of the aircraft loaded with hospital modules according to an embodiment;

FIG. 3 is a schematic diagram of a section of the aircraft through the hybrid OR of FIG. 2 according to an embodiment; and

FIG. 4 is a schematic diagram of an example of a module in two perspective views designed for a specific aircraft.

FIG. 5 is a schematic diagram of a section of the aircraft showing the process of loading or unloading the hospital modules in the aircraft according to an embodiment;

FIG. 6 is a schematic diagram of perspective view of the aircraft showing the process of loading or unloading the hospital modules in the aircraft according to an embodiment;

FIG. 7 are schematic diagrams of two deployable modules according to an embodiment, showing loaded modules for transportation and processes of automated unloading of a module from the aircraft according to an embodiment;

FIG. 8 is a schematic diagram of a mobile transportation system with modules selected per mission goals in in-transit configuration according to an embodiment;

FIG. 9 is a schematic diagram of a mobile transportation system in operational configuration on the ground with same modules from FIG. 8 selected per mission goals in according to an embodiment;

FIG. 10 is a perspective diagram showing deployed hospital modules forming fully functional medical facility according to an embodiment; left side is a perspective view of the medical facility; the right side of the diagram shows a top view of the hospital with section through the OR and ICU modules; FIG. 10a is a top plan view of FIG. 10 and FIG. 10b is a cross section view of FIG. 10a along the lines 10b, 10b.

FIG. 11 is a schematic diagram of perspective view mobile transportation system in transit configuration of FIG. 8 according to an embodiment;

FIG. 12 is a schematic diagram of mobile transportation system on the ground of FIG. 9 according to an embodiment.

### OVERVIEW

The disclosure is an aerospace transport system consisting of many modules containing hospital medical equipment, including medical imaging, water, and power generators, and NBC (Nuclear, Biological, and Chemical) air purification systems. These modules can be connected to establish a comprehensive, self-sufficient hospital system capable of providing both first aid and sophisticated surgical interventions, as proactive and reactive continuing care. The modules are designed to optimize the use of space within the aerospace object, and they can be assembled to create an onboard hospital system, although, the modules are not meant to be used during flight. The modules are also designed so that they can be deployed on the ground or in space to form a standalone hospital system with the same functionality as on board. Additionally, once deployed the modules can be used to create a scalable medical facility that provides longer-term service. By scalable we mean adding more modules as needed eighter from same flights or subsequent flights. If necessary, the aerospace transport unit can be used to transport more modules to increase the size and functionality of the hospital built on the ground, thus making it suitable for longer-term use in emergency situations or disaster relief efforts. The disclosure offers a novel and innovative solution for providing medical support in remote areas or emergency situations by providing a transportable, scalable, and self-sufficient hospital system with the necessary equipment and supplies to address medical needs.

### DETAILED DESCRIPTION

The system comprises a plurality of modules that are specifically built for their intended purpose. The modules include self-sufficient hospital facilities, medical device manufacturing facilities, vaccine production facilities, pharmaceutical production facilities, sterilization facilities, food production facilities, atmospheric water production, air cleaning, power modules, and accommodation facilities, completely independent from any infrastructure when assembled per the goal of the mission. By goal we mean that different modules will be assembled in a war zone as opposed to a flood zone. The modules of the aerospace-based healthcare system are designed to provide sufficient space for the equipment, staff and patients required for proper operation on board of the transportation system. The deployable modules provide proper roofing and power, water, and air connectivity with other modules. The flooring of each module is isolated and has a closed connection with other modules to prevent any contamination. For example, rubber connections and/or mechanical connections.

The aerospace-based mobile hospital system described in this disclosure is designed to address the urgent medical needs of patients in remote areas, but also in areas that have been affected by natural disasters or military conflicts. In such situations, it is often difficult or impossible to provide medical care using traditional hospital facilities due to limited accessibility, infrastructure damage, or lack of available medical resources. This mobile hospital system overcomes these challenges by offering a self-contained solution that can be quickly deployed to provide comprehensive diagnoses and medical treatments to many patients. The system is based on (A) an aerospace-based transport system that can transport (B) a plurality of modules containing, but not limited to medical equipment, including medical imaging, water and power generators, and air purification systems. (C) The modules are designed to optimize the use of all the space within the aerospace object and can be connected to form an onboard hospital system or deployed on the ground to create a standalone hospital system. The modular design enables the hospital system to be scalable, with additional modules transported to increase the size and functionality of the hospital. The aerospace-based mobile hospital system can be used to provide emergency medical care in various situations, including natural disasters, military conflicts, and remote areas where medical facilities are not available. It offers a unique solution for addressing urgent medical needs in challenging and rapidly changing environments, including climate change, and can help save lives and reduce suffering in times of crisis.

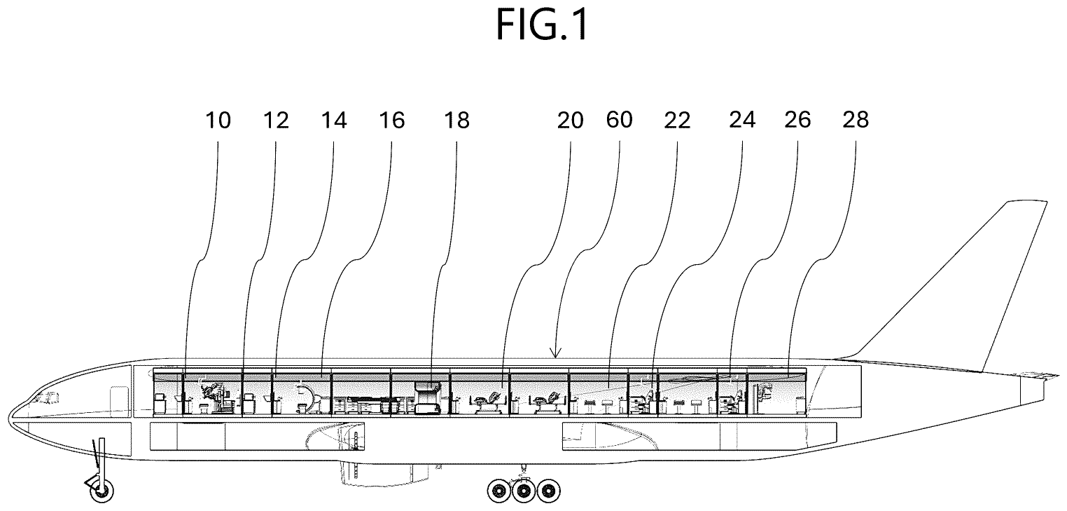

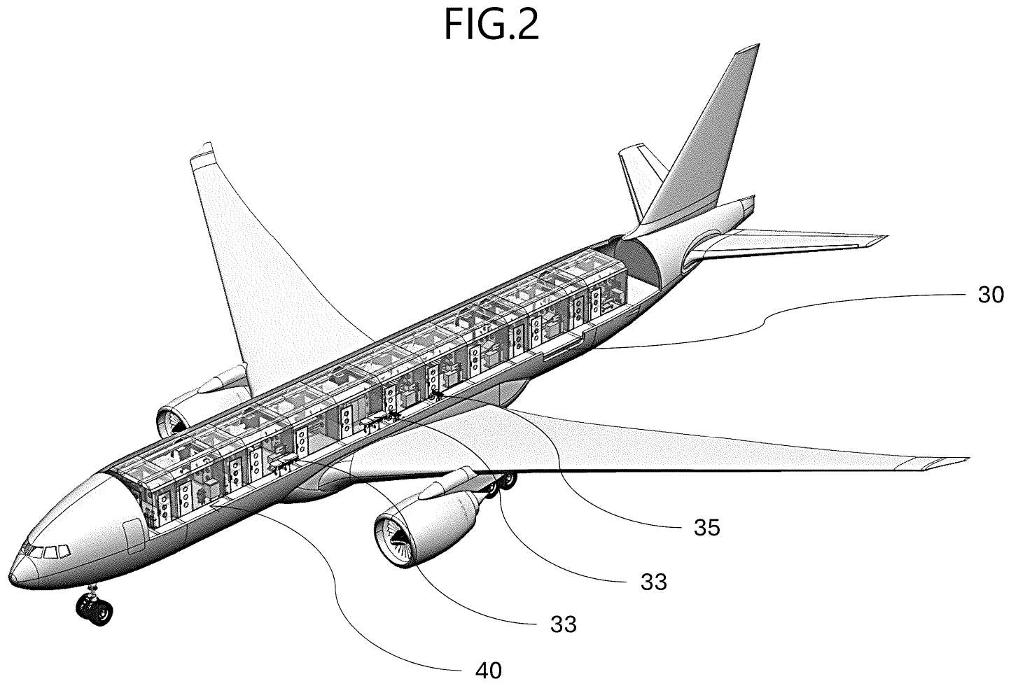

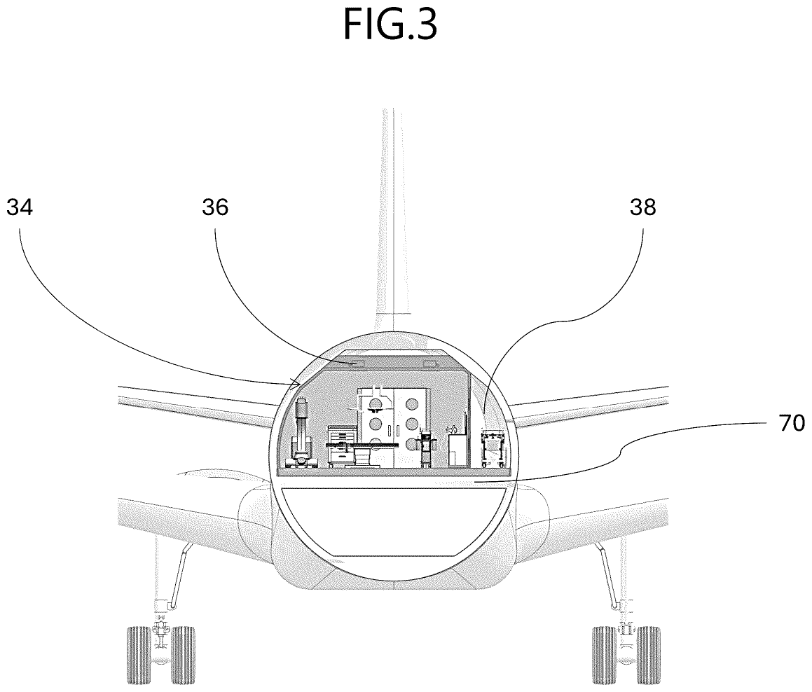

FIGS. 1 and 2 depict plane or aircraft 60 as a scenario illustrating multiple modules 10, 12, 14, 16, 18, 20, 22, 24, 26, and 28 arranged sequentially along the longitudinal length of the plane 60 on the aircraft's board. In FIG. 1, ten modules are showcased, each tailored for specific functionalities including medical equipment for operating rooms (OR) 12 and 16, OR preparation and washrooms 10 and 14, CT scanner and hybrid operation room 18, intensive care units 20, general examination rooms 22, otolaryngology surgery 24, dental surgery 26, and gynecology diagnostics and operations 28. Accessible through the aircraft's door 30, these modules are seamlessly interconnected via a walking surface 40, depicted in the cross-sectional view on FIG. 3 as 38 is a walking corridor. The corridor shows beds or stretchers 33 and wheelchairs 35.

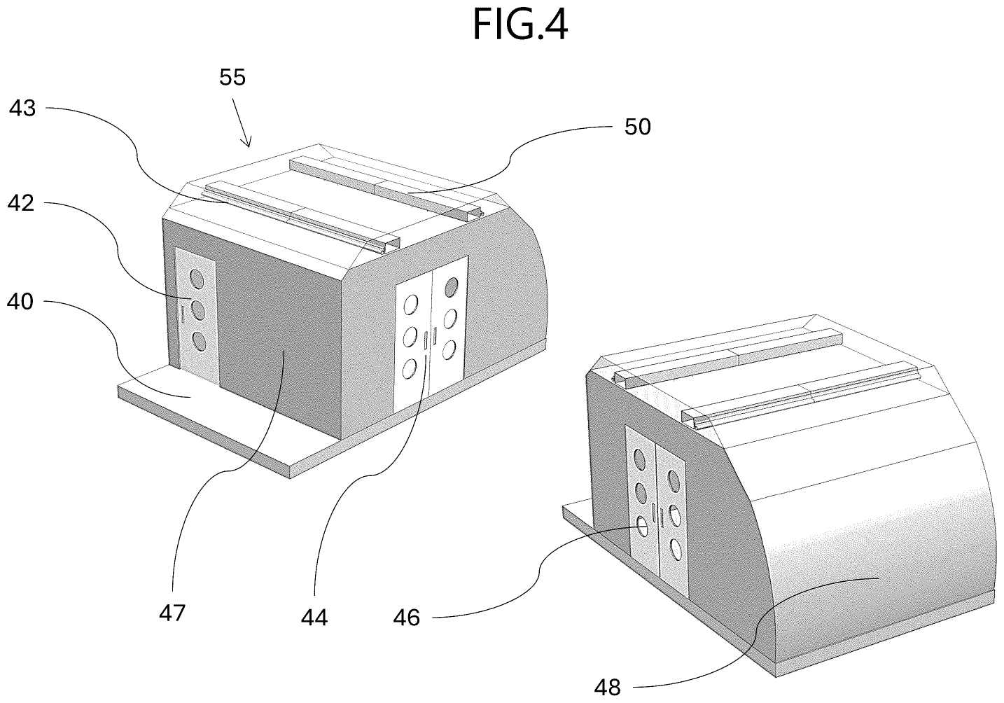

Illustrated in FIG. 4 is module 55 designed to maximize space utilization within the cross section of the plane 60 shown in FIG. 3. It features a walking surface or platform 40 facilitating movement around module 55, a sliding door for entry 42, and sliding double doors 44 and 46 facilitating interconnection with adjacent modules when assembled. These doors can be left open to create a larger unified space for equipment and operations as necessary. Atop the module, integral components of the infrastructure system such as electrical cables, HVAC ducts 50, communication cables, fire suppression elements, and water pipes 43 are installed also shown as 36 on FIG. 3. Upon assembly as depicted in FIG. 2, these components seamlessly integrate, collectively forming the infrastructure of the medical facility they collectively constitute. Modules 55 have a vertical or first side surface 47, presenting entry 42 and opposite surface 48 contoured to match or fit the contour of the fuselage or shell 34 of the plane 60 as shown in FIG. 3 to maximize the usage of the plane 60.

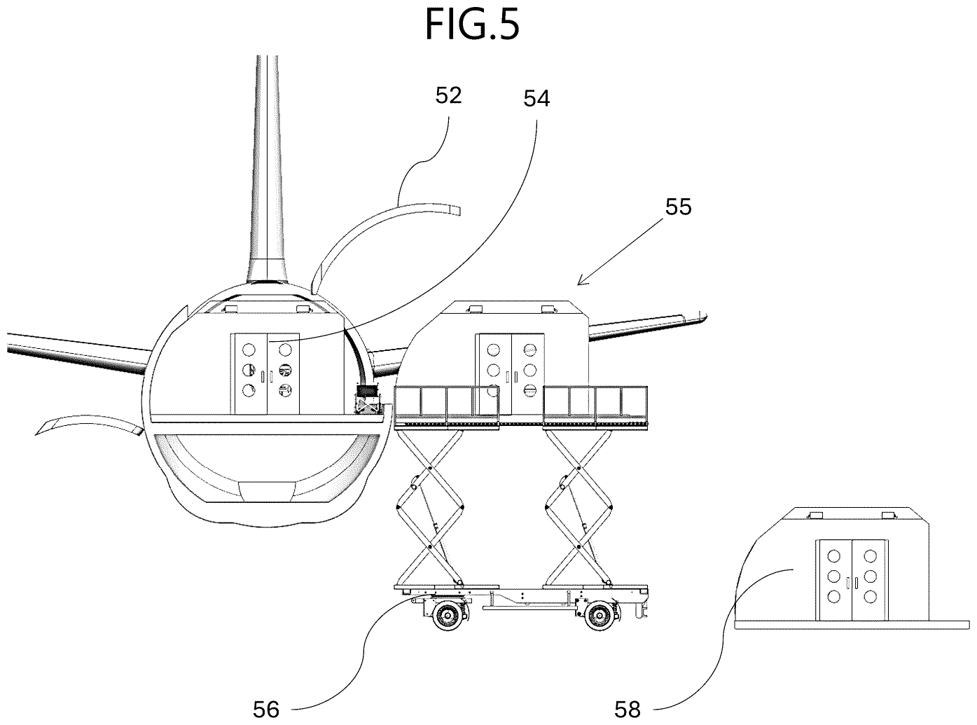

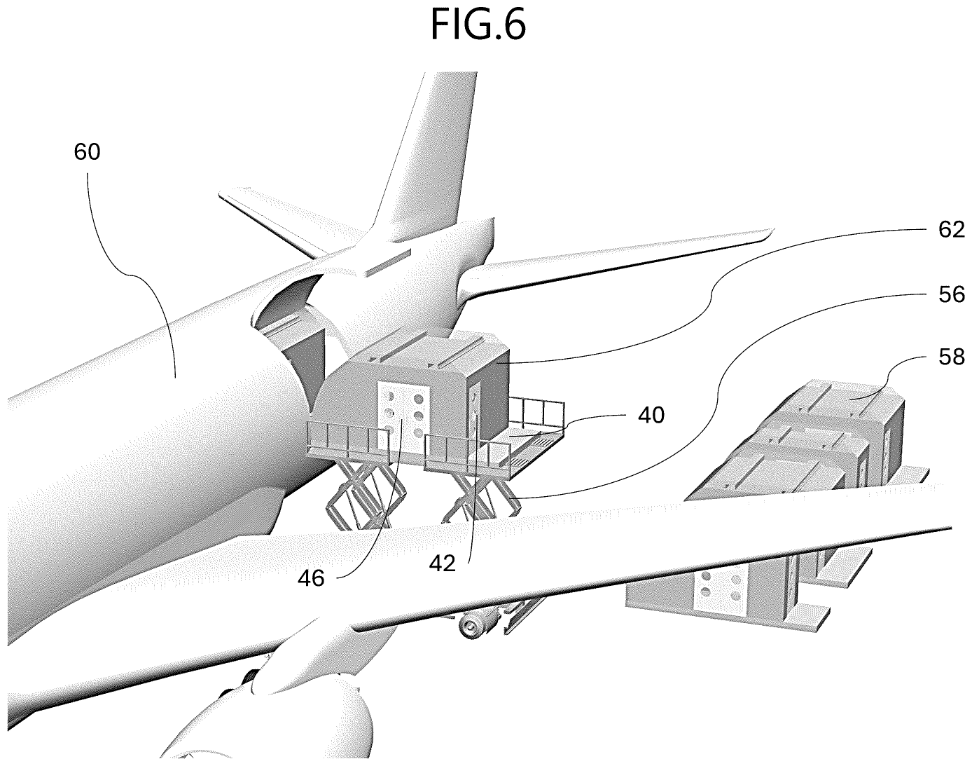

FIGS. 5 and 6 depict a process demonstrating the loading of modules 55 onto an aircraft 60 through its cargo door 52. Initially situated on the ground, the modules 58 are elevated to the position 62 of the aircraft's deck level using a standard or specifically designed lift 56. Subsequently, they are maneuvered inside the aircraft 54 and interconnected with other loaded modules.

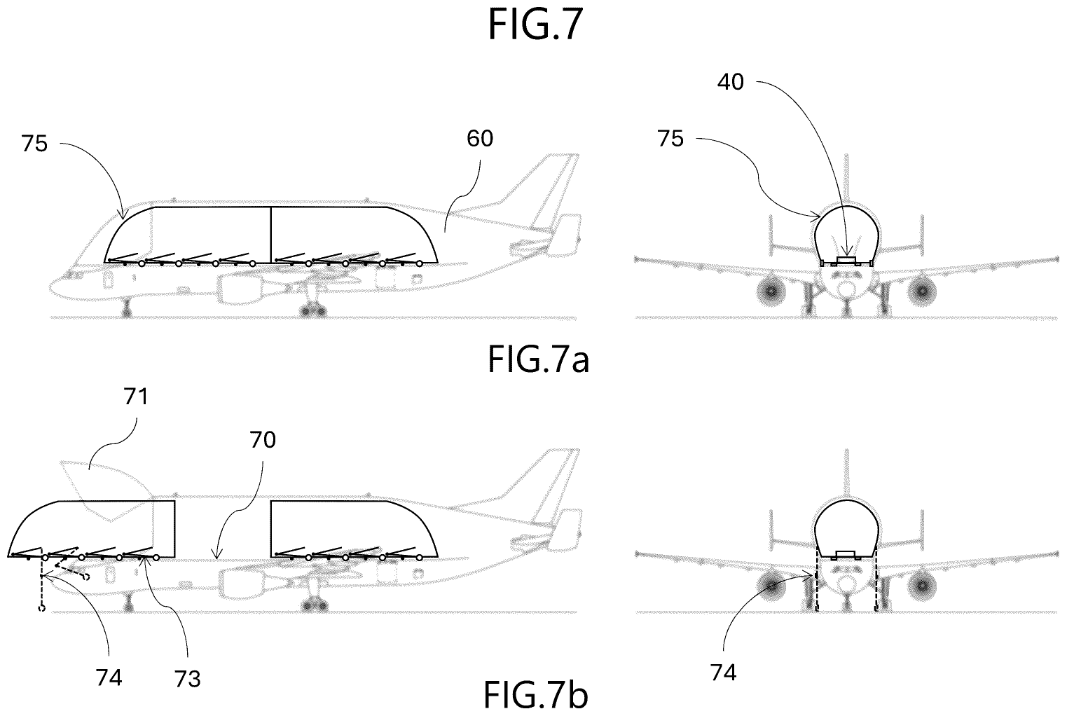

Displayed in FIG. 7 is an example of another embodiment of a plane 60, such as Airbus Beluga, where the nose cone 71 pivots permitting loading and unloading of modules 55 designed to maximize space utilization and integrate and automate the loading and unloading lift. In this case module 55 has retracting and extending wheels 73 to automatic load or unload the modules 55. FIG. 7 shows that modules 55 can include curved surface 75 in both the longitudinal section of the plane as well as in the cross section (so the module is like a dome shaped). Walking surface 40 in such designed modules 55 is at the middle of the module 55. FIG. 7a shows two modules 55, loaded for transportation. FIG. 7b shows in solid lines the wheels in retracted position 73 and in hidden lines in extended position 74. FIG. 7b. shows unloading of the front module in progress and how the wheels extend 74 subsequently and following the direction of movement to ensure the module remains at the level of the aircraft's deck 70 during the process. For certain aerospace objects automated loading and unloading can be considered and integrated, meeting all the safety standards.

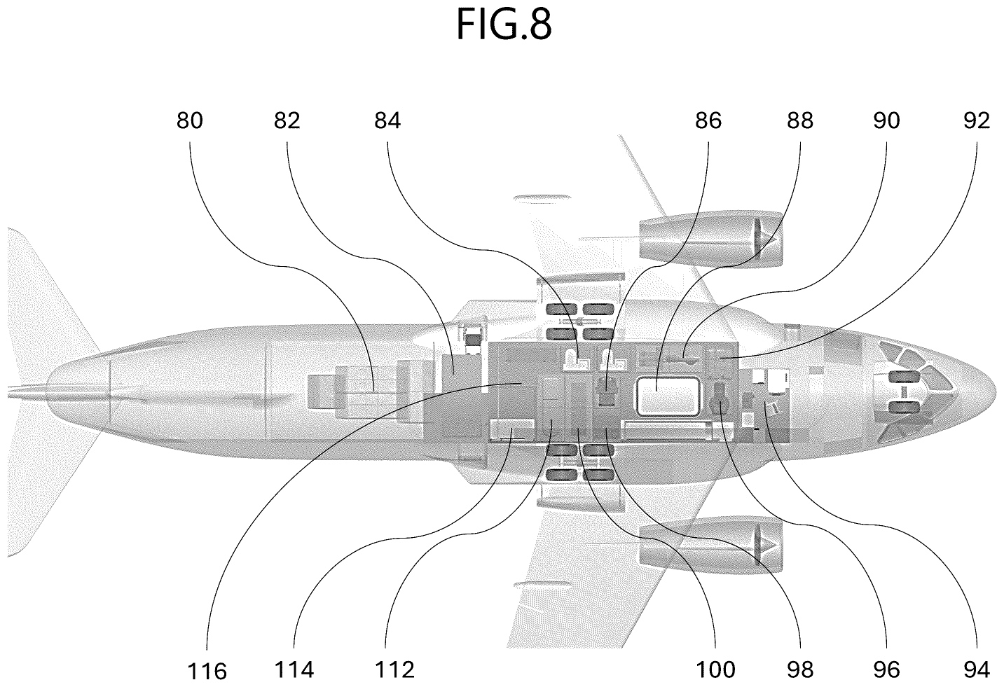

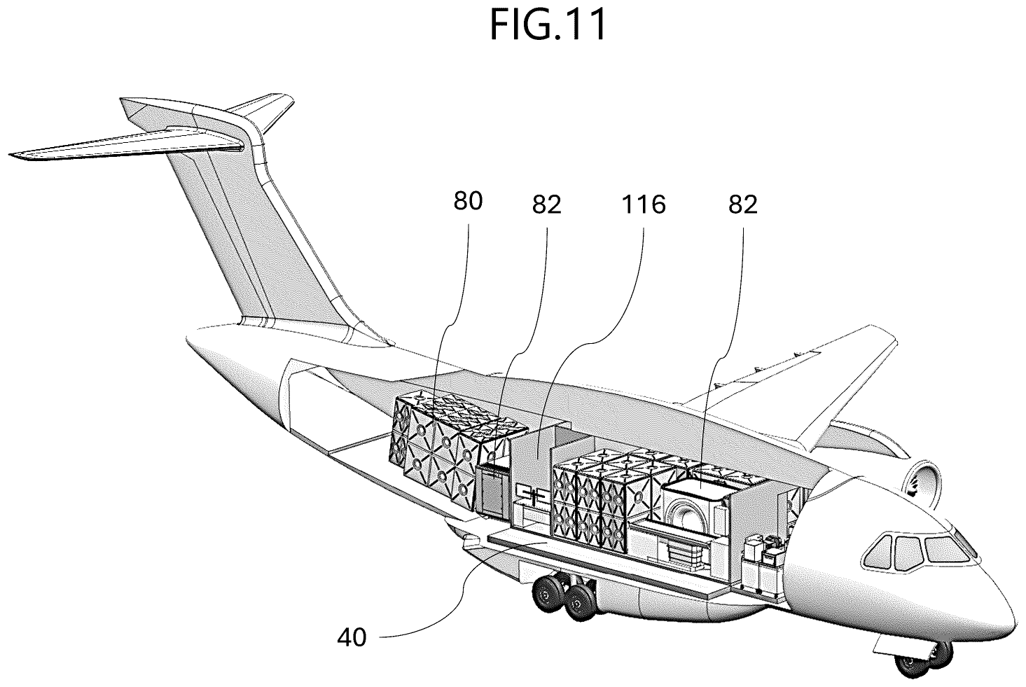

FIG. 8 exhibits an aircraft loaded with modules for imaging diagnostics 116. Here, the CT scanner 88 is arranged in a transit configuration to accommodate medical equipment containers, which are transported and then deployed into an inflatable building 80 also conveyed by the same flight and shown on FIG. 8 and FIG. 11 in flatten configuration and in containers. Additionally, the transport unit includes module 82 equipped with water and power generators, along with an air purification system, as well as module 84 containing washrooms necessary for the self-sufficient operation of the entire transported healthcare facility. The medical equipment containers consist of an ultrasound unit 86, C-arm X-Ray 90, C-arm monitor 92, mammograph 96, anesthesiology equipment 98, and examination beds 112, including an OR bed 100.

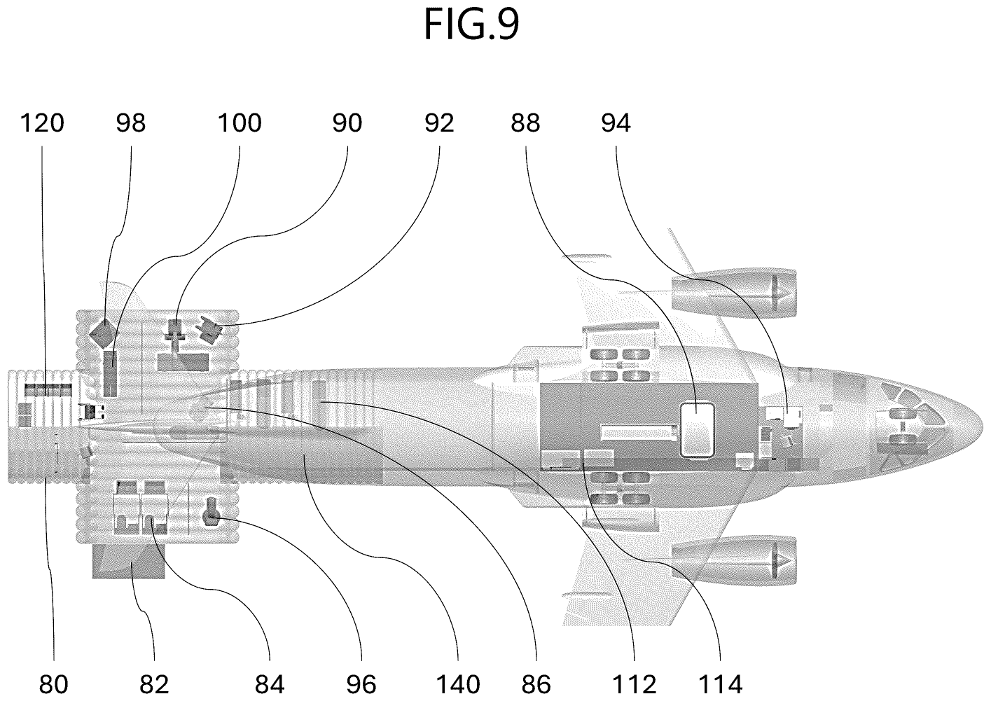

FIG. 9 illustrates another embodiment of aircraft 60 but in an operational clinic configuration with triage area 120. Once deployed, inflatable structure 80 remains connected to the aircraft via tunnel 140, isolated from the environment along with the inflatable structure's components. The imaging diagnostics module in operational configuration 116, along with the module comprising laboratory and bloodwork equipment 94, remain operational on board the landed aircraft and are not deployed. All medical equipment containers are unloaded from the aircraft and arranged within the inflatable structure 80, providing necessary isolation from the elements and protection for medical personnel and patients in the deployed healthcare facility.

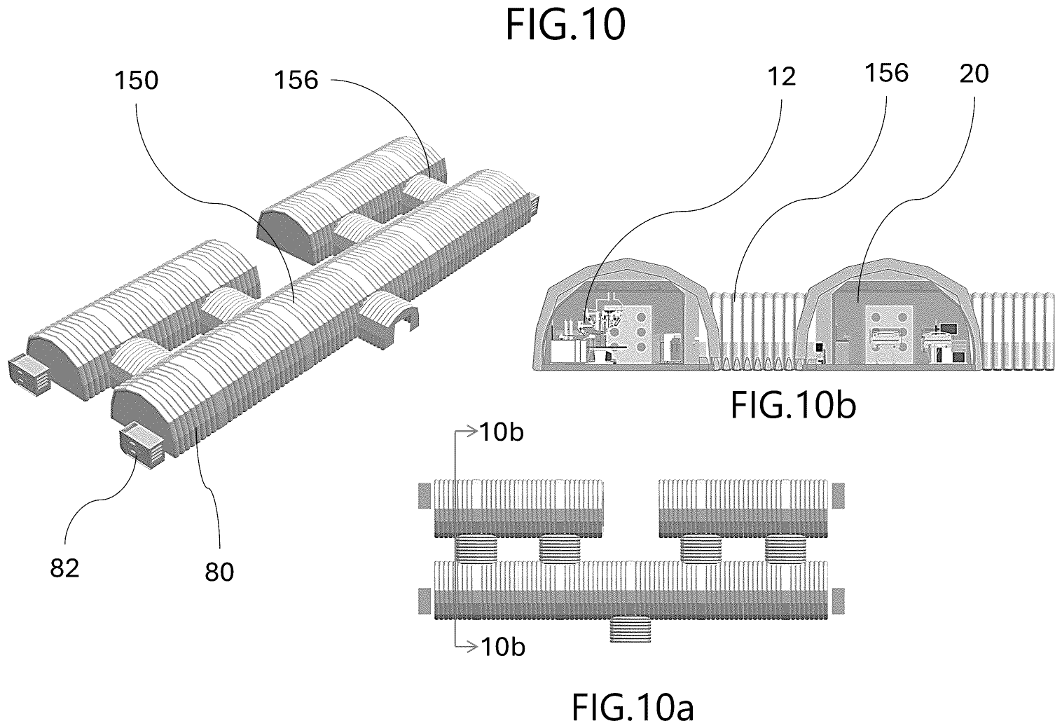

FIG. 10 portrays a larger structure 150 assembled from smaller inflatable buildings 80 containing numerous medical modules arrived with one or multiple flights. For clarity, a sectional view FIG. 10b is created through the OR module 152 and ICU module 20, illustrating tunnels 156 connecting all facilities to form a fully operational hospital facility.

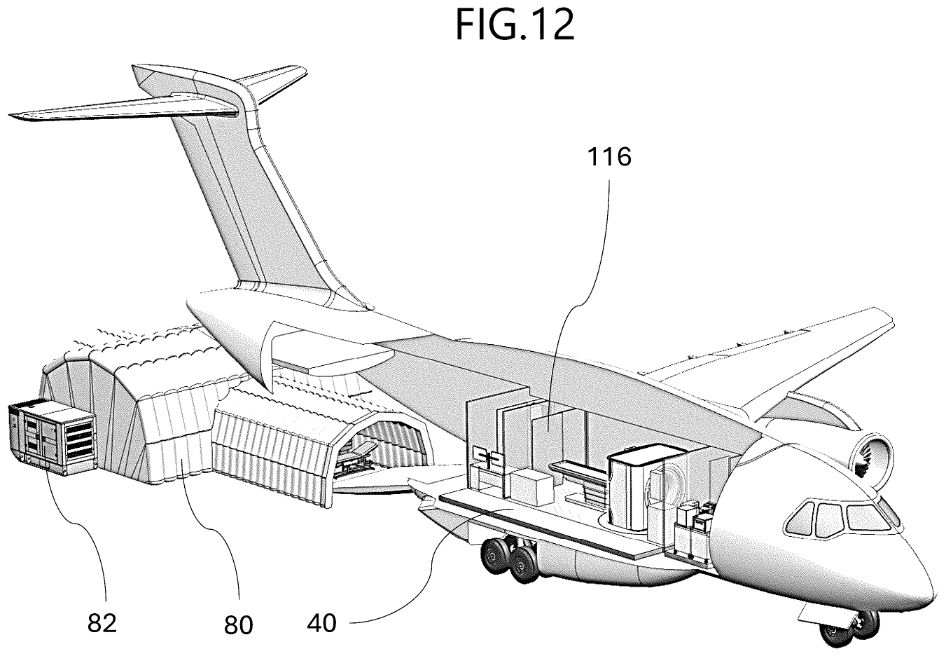

FIGS. 11 and 12 provide perspective views of both configurations depicted in FIGS. 8 and 9.

Example testing and diagnostics onboard of aerospace objects or by deployment of transported modules include but is not limited to:
Blood tests (CBC, liver function tests, thyroid function tests, cholesterol screening, etc.)
Urine tests (urinalysis, drug tests).
Imaging tests (X-rays, CT scans, MRI scans, PET scans, etc.)
Electrocardiogram (ECG or EKG)
Electroencephalogram (EEG)
Biopsy
Colonoscopy
Pap smear
Mammogram
Pulmonary function tests
Endoscopy
Physical examination
Medical history
Observation
Laboratory tests
Imaging tests
Biopsy
Endoscopy
Genetic testing

Example of treatments onboard units of aerospace objects or by deployment of transported modules include but is not limited to:
Medications (antibiotics, pain relievers, chemotherapy, etc.)
Surgery
Radiation therapy
Immunotherapy
Hormone therapy
Stem cell transplant
Physical therapy
Psychotherapy
Alternative therapies (acupuncture, massage, chiropractic, etc.)

According to a first aspect of the disclosure, aerospace-based mobility can be achieved using various means of transportation, such as but not limited to aircraft, long-range (over 500 km) airships, drones, spacecraft, trains, ocean floor stabilized jack ships, eVTOL and VTOL (vertical takeoff and landing). To ensure safety, particularly when operating in or near military conflicts, the aircraft object is equipped with military-grade self-defense systems, as well as zero-visibility systems, an all-weather landing system, and an X-Sight Helmet Display system. The aerospace object, which by definition include spaceships and space stations, contains a plurality of modules 55, including a self-sufficient hospital facility, small-scale medical device manufacturing facility, vaccine production facility, pharmaceutical production facility, sterilization facility, and food production facility, as well as an accommodation facility. Each module 55 can be unloaded from the aerospace object and connected to other modules to become part of a larger modular facility with specific purposes. This allows for customization of the facility depending on the medical or other needs of the situation. The modular system can be easily transported to remote areas or areas affected by natural disasters or military conflicts to provide immediate medical care and other necessary facilities. The disclosure offers a unique solution for addressing urgent needs in challenging environments, including climate change, and can help save lives and improve living conditions in times of crisis. The aerospace mobility system includes patient transport (for example ambulance, stretcher, other vehicle) units to and from the hospital in addition to resupplying all units within the mobile advanced surgical hospital ecosystem integrated advanced manufacturing facilities and supply chain.

A second aspect of this disclosure is a system of modules that can be used to build various establishments, including hospitals and other facilities for providing life support and services in remote or disaster-stricken areas. These modules are designed to be easily transportable and can be connected to form various facilities tailored to their purpose. For example, they can be used to construct surgical, and CT/MRI equipped hospital systems, humanitarian missions, and other establishments that provide support to remote areas or areas affected by natural disasters or military conflicts.

The modules 55 include a range of medical equipment for diagnosis, imaging, and surgery. Diagnostic equipment includes but is not limited to electroencephalography machines, and ultrasonography machines. Medical imaging equipment includes but is not limited to X-ray machines, CT scanners, MRI scanners, ultrasound, and echocardiography machines.

The modules also feature fully equipped operating rooms, including robotic and hybrid operating rooms, for a range of surgeries including but not limited to orthopedic, cardiovascular, neurosurgery, gastrointestinal, urological, ophthalmologic, and gynecologic surgeries. The medical laboratory within the module is equipped with a range of diagnostic equipment, including those for chemistry, microbiology, hematology, virology, histology, immunology and molecular diagnostics, and a blood bank.

The system also includes an intensive care unit and various powering systems, including solar, hydro, wind, battery, fuel cells, liquid fuel cells, micro-nuclear, and micro-fusion. Additionally, there are water generators, such as atmospheric, and NBC (nuclear, biological, and chemical) air handling and purification systems included within the modules.

Deployed ground and space modules are contained within a sealed pressured envelope which is constructed with advanced materials which are both ballistically rated and fireproof for safety.

A third aspect of the disclosure is related to the design of modules 55 for optimal function and compatibility with the aerospace object. The modules 55 are designed to provide sufficient space for the equipment and staff to operate properly. They are sized to fit optimally and conform with all available volume by precision spatial fit conforming to all usable surfaces within the aerospace unit of the aerospace object and are properly attached and securely locked and anchored to its structure for safe transportation and deployment when needed, and recertification upon deployment. The deployable modules are also designed with a proper roof to protect the equipment from the elements. Additionally, they are equipped with power, water, and NBC air connectivity to allow for seamless integration with other modules. Finally, the modules are designed with an isolated and closed connection of the flooring with other modules to prevent contamination and ensure the safety of patients and staff.

1. A mobile transportation system, having a plurality of modules, including a self-sufficient hospital facility, small-scale medical device manufacturing facility, vaccine production facility, pharmaceutical production facility, sterilization facility, and food production facility, as well as an accommodation facility; wherein each of said plurality of modules, when necessary can be unloaded from the aerospace object and connected to other modules to become part of a larger modular facility with specific purposes, to allows for customization of the facility depending on the medical or other needs.

2. The mobile transportation system as claimed in claim 1 wherein each of said plurality of modules can be transported to remote areas or areas affected by natural disasters or military conflicts to provide immediate medical care on board of the aerospace object and/or become part of other necessary facilities.

3. The mobile transportation system as claimed in claim 2 wherein said plurality of modules build various establishments, including hospitals and other facilities for providing life support and services in remote or disaster-stricken areas; said plurality of modules being easily transportable and interconnectable to form various facilities tailored to their purpose.

4. The mobile transportation system as claimed in claim 3 wherein said plurality of modules can be used to construct surgical, medical imaging and diagnostic modalities equipped hospital systems, humanitarian missions, and other establishments that provide support to remote areas or areas affected by natural disasters or military conflicts.

5. The mobile transportation system as claimed in claim 1 comprising aircrafts, long-range (over 500 km) airships, drones, spacecraft, trains, ocean floor stabilized jack ships, eVTOL and VTOL (vertical takeoff and landing) and further to ensure safety, particularly when operating in or near military conflicts, the aircraft object is equipped with military-grade self-defense systems, as well as zero-visibility systems, an all-weather landing system, and an X-Sight Helmet Display system.

6. The mobile transportation system as claimed in claim 5 wherein said modules:
a) are designed to provide sufficient space for the equipment and staff to operate properly, as well as to provide shielding where necessary;
b) sized to fit optimally and conform with all available volume by precision spatial conforming to all usable surfaces within the aerospace unit of the aerospace object and are properly attached and securely locked and anchored to its structure for safe transportation and deployment when needed, and recertification upon deployment;
c) are designed with a proper roof to protect the equipment from the elements;
d) equipped with power, water, and NBC air connectivity to allow for seamless integration with other modules; and
e) designed with an isolated and closed connection of the flooring with other modules to prevent contamination and ensure the safety of patients and staff.

7. A medical module for an aerospace vehicle comprising:
a) a top surface spaced from a bottom surface,
b) first and second spaced ends;
c) a first side surface spaced from a second side surface, wherein the second side surface is different from said first side surface;
d) wherein said bottom surface extends beyond said first side surface to present a walking surface; and
e) wherein said top bottom and first and second side surfaces are configured to maximize the use of an interior of said aerospace vehicle.

8. A medical module as claimed in claim 7 wherein said aerospace vehicle comprises an airplane extending longitudinally to present a shell and deck, and a plurality of said modules disposed longitudinally end to end within said shell; wherein said walking surface of each said plurality of modules are aligned and define a corridor between said walking surface, said first side surface and a portion of said shell.

9. A medical module as claimed in claim 8 wherein said second surface is curved to conform to the shell.

10. A medical module as claimed in claim 9 wherein a number of said plurality of said modules are selective moveable from said aerospace vehicle to be placed end to end on an exterior surface.

11. A medical module as claimed in claim 10 wherein said plurality of modules are selected from the group of blood test, liver function test, thyroid function test, cholesterol screening test, urine test, imaging test, electrocardiogram, electroencephalogram, biopsy, colonoscopy, pap smear mammogram, pulmonary function test, endoscope, physical examination medical history, observation, laboratory test, genetic testing, medication treatment, surgery, radiation therapy, immunotherapy, hormone therapy, stem cell transplant, physical therapy, psychotherapy and alternative medicine therapy modules.

12. A medical module as claimed in claim 11 wherein said first surface of each said plurality of modules is vertical and presents an access door into said module.

13. A medical module as claimed in claim 12 wherein each said module of said plurality of modules present first and second end doors that longitudinally align with one another.

14. A medical module is claimed in claim 13 wherein said module defines medical facilities.

15. A medical module has claimed in claim 7 wherein said module presents an access door in said first side surface to present an opening into said module from said walking surface.

16. A medical module has claimed in claim 15 wherein in each said module presents a door on the end to communicate with each said module.

17. A medical module has claimed in claim 16 wherein a said plurality of modules are selectively removable for end to end connection to each other on the exterior surface.

18. A medical module has claimed in claim 17 defining a movable hospital.
